(19) United States
(12) Patent Application Publication
(10) Pub. No.: US 2022/0207273 A1
(43) Pub. Date: Jun. 30, 2022

(54) METHODS AND APPARATUSES FOR IDENTIFYING OPERATION EVENT

(71) Applicant: SENSETIME INTERNATIONAL PTE. LTD., Singapore (SG)

(72) Inventor: Jinyi WU, Singapore (SG)

(21) Appl. No.: 17/342,794

(22) Filed: Jun. 9, 2021

Related U.S. Application Data
(63) Continuation of application No. PCT/IB2021/053495, filed on Apr. 28, 2021.

(30) Foreign Application Priority Data
Dec. 31, 2020 (SG) 10202013260Q

(51) Int. Cl. G06K 9/00; G06T 7/20; G06T 7/70; G07F 17/32

(52) U.S. Cl. CPC G06K 9/00718; G06T 7/20; G06T 7/70; G06K 2209/21; G06T 2207/10016; G06K 2009/00738; G07F 17/322

(57) ABSTRACT

Methods, apparatus, and for identifying operation events are provided. In one aspect, a method include: performing object detection and tracking on at least two image frames of a video to obtain object-change-information of an object contained in at least two image frames, the object being an operable object, and determining an object-operation-event that has occurred based on the object-change-information of the object.

### CROSS REFERENCE TO RELATED APPLICATION

This application is a national phase application of International Application No. PCT/IB2021/053495 filed on Apr. 28, 2021, which claims priority to Singapore Patent Application No. 10202013260Q, filed on Dec. 31, 2020, entitled “METHODS AND APPARATUSES FOR IDENTIFYING OPERATION EVENT,” the disclosure of which is incorporated herein by reference in its entirety for all purposes.

### TECHNICAL FIELD

The present disclosure relates to image processing technology, and in particular to methods and apparatuses for identifying an operation event.

### BACKGROUND

With development of technology, ever highly intelligence demand has been put out in an increasing number of scenarios. For example, one of the demands is implementing automatic identification and recording events that occur in a scenario (for example, the scenario can be a game venue). The event that occurs in the scenario can be an operation event, and the operation event can be operations such as movement or removal of an object in the scenario by a participant in the scenario. How to automatically capture and identify the occurrence of these operation events is a problem to be solved in building an intelligent scenario.

### SUMMARY

In view of this, the examples of the present disclosure provide at least a method and an apparatus for identifying an operation event.

In a first aspect, a method for identifying an operation event is provided, and the method includes: performing object detection and tracking on at least two image frames of a video to obtain object-change-information of an object involved in the at least two image frames, wherein the object is an operable object; and determining an occurred object-operation-event based on the object-change-information.

In a second aspect, an apparatus for identifying an operation event, and the apparatus includes: a detection processing module configured to perform object detection and tracking on at least two image frames of a video to obtain object-change-information of an object contained in at least two image frames, wherein the object is an operable object; and an event determining module configured to determine an object-operation-event that has occurred based on the object-change-information of the object.

In a third aspect, an electronic device is provided. The device can include a memory and a processor, the memory is configured to store computer-readable instructions, and the processor is configured to invoke computer instructions to implement the method for identifying an operation event of any of the examples of the present disclosure.

In a fourth aspect, a computer-readable storage medium is provided, on which a computer program is stored, and when the program is executed by a processor, the method for identifying an operation event of any of the examples of the present disclosure is implemented.

In a fifth aspect, a computer program is provided, including computer-readable codes which, when executed in an electronic device, cause a processor in the electronic device to perform the method for identifying an operation event of any of the examples of the present disclosure.

With the methods and apparatuses for identifying an operation event according to the examples of the present disclosure, object-change-information of an object involved in a video can be obtained by detecting and tracking the object in image frames of the video, so that a respective object-operation-event can be automatically identified based on the object-change-information, which can achieve automatic identification of events.

### BRIEF DESCRIPTION OF THE DRAWINGS

In order to more clearly illustrate the technical solutions in one or more examples of the present disclosure or related technologies, the following will briefly introduce the accompanying drawings that need to be used in the description of the examples or related technologies. Apparently, the accompanying drawings in the following description show only some of the examples recorded in one or more examples of the present disclosure. For those of ordinary skill in the art, other drawings can be obtained based on these drawings without creative labor.

FIG. 1 shows a schematic flowchart illustrating a method for identifying an operation event according to at least one example of the present disclosure;

FIG. 2 shows a schematic flowchart illustrating another method for identifying an operation event according to at least one example of the present disclosure;

FIG. 3 shows a schematic diagram illustrating a game table scenario according to at least one example of the present disclosure;

FIG. 4 shows a schematic diagram illustrating operation event identification of a game token according to at least one example of the present disclosure;

FIG. 5 shows a schematic block diagram of an apparatus for identifying an operation event according to at least one example of the present disclosure.

### DETAILED DESCRIPTION OF THE EMBODIMENTS

In order to enable those skilled in the art to better understand the technical solutions in one or more examples of the present disclosure, the following will be combined with the drawings in one or more examples of the present disclosure to compare the technical solution described clearly and completely. Apparently, the described examples are only a part of the examples of the present disclosure, rather than all the examples. Based on one or more examples of the present disclosure, all other examples obtained by those of ordinary skill in the art without creative work should fall within the protection scope of the present disclosure.

The examples of the present disclosure provide a method for identifying an operation event, and the method can be applied to automatically identify operation events in a scenario. An item included in the scenario can be referred to as an object, and various operations such as removing and moving the object can be performed on the object through an object operator (for example, a human hand or other object holding tool which can be a clip, for example). By installing a capturing device (such as a camera) in an intelligence scenario, this method can capture a video of the operation event and automatically identify the object-operation-event on the object through the object operator (for example, the item is took away by a human hand) by analyzing the video.

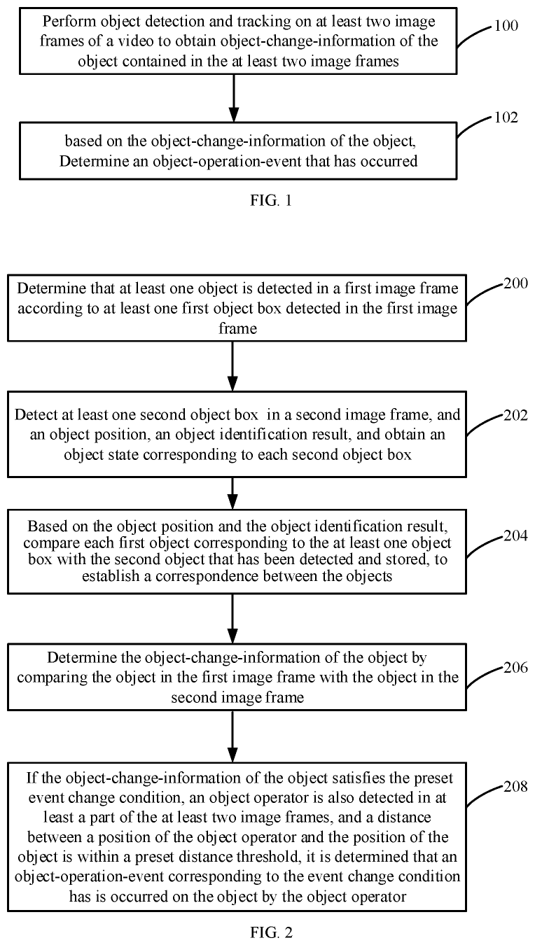

As shown in FIG. 1, a flowchart illustrating a method for identifying an operation event according to at least one example of the present disclosure is shown. As shown in FIG. 1, the method can include the following steps.

At step 100, object detection and tracking are performed on at least two image frames of a video to obtain object-change-information of the object contained in the at least two image frames, where the object is an operable object.

At this step, the video can be a video in a scenario where an event has occurred, which is captured by a camera provided in the scenario. The event occurrence scenario can be a scenario that contains characters or things and the states of the characters or things have changed. As an example, the scenario can be a game table. The video can include a plurality of image frames.

The at least two image frames of the video can be at least two consecutive image frames in the video, or can be at least two image frames sequentially selected in chronological order after sampling all the image frames in the video.

The image frames in the video can contain “objects”. An object represents an entity such as a person, an animal, and an item in the scenario of the event. As an example, taking the game table scenario as an example, game tokens on the game table can be referred to as “objects”. For another example, an object can be a stack of game tokens stacked on a game table. The object can be included in the image frame in the video captured by the camera. Of course, there can be more than one object in the image frame.

The objects in the scenario are operable objects. The operable object here refers to that the object has operability. For example, the object can change part of the properties of the object under an action of an external force. The properties include but are not limited to: for example, a number of components in the object, a standing/spreading state of the object, and so on.

By performing object detection and tracking on at least two image frames, it is possible to obtain how each object has changed in different image frames in time sequence, that is, obtain object-change-information of the object. For example, an object detected in the previous image frame no longer appears in the subsequent image frame, or the state of an object has changed (for example, the standing state has become the spreading state).

At step 102, based on the object-change-information of the object, an object-operation-event that has occurred is determined.

If any object-change-information of the object is detected, it can be considered that an object-operation-event that causes the object to change has occurred. It is the occurrence of the object-operation-event that causes the object to change, thereby obtaining the object-change-information of the object. Based on this, at this step, the object-operation-event can be determined based on the object-change-information of the object. As an example, if the detected object-change-information of the object is that the state of the object has changed from standing to spreading, then the corresponding object-operation-event is “spreading out the object”.

In an example, some event occurrence conditions can be defined in advance. The event occurrence condition can be predefined object-change-information of at least one of attributes such as the state, position, number, and relationship with other objects of an object, which is caused by an object-operation-event.

For example, taking the object-operation-event “removing an object” as an example, if an event of removing an object occurs, it should be detected in the image frames of the captured video that the object can be detected initially, but cannot be detected later (i.e. disappeared). In this case, the event occurrence condition corresponding to the event of removing the object can be that “based on the object-change-information of the object, it is determined that the object is detected to disappear in the video”.

Since there can be many kinds of object-operation-events that can occur, for example, removing an object, dropping an object, changing an object from a standing state to a spreading state, and so on, correspondingly, for each object-operation-event, a corresponding event change condition can be preset. After the object-change-information of the object is detected at step 100, it is possible to continue to confirm what has changed in the object based on the object-change-information, and whether the change satisfies the preset event change condition. If the object-change-information of the object satisfies the preset event change condition, the object operator is also detected in at least a part of the at least two image frames of the video, and a distance between the position of the object operator and the position of the object is within a preset distance threshold, it can be determined that an object-operation-event corresponding to the event change condition is occurred by the object operator operating on the object.

The object operator can be an item used for operating the object, such as, a human hand, an object holding tool, and so on. Generally, the object-operation-event occurs because the object operator has performed operation, and the object operator comes into contact with the object when operating the object. Therefore, in the image frames, the detected distance between the object operator and the object is not too far, and the presence of the object operator can usually be detected within the position range of the object. The position range of the object here refers to an occupied area including the object, or a range within a distance threshold from the object. For example, within a range of about 5 cm from the object centered on the object. Taking a human hand taking an object as an example, when the object-operation-event of the human hand taking the object occurs, the human hand contacts the object and then takes it away. At least a part of the image frames of the captured video can have the human hand within the position range of the object. In some image frames, it is also possible that the human hand is not in direct contact with the object, but the distance to the object is very close, and it is within the position range of the object. This very close distance can also indicate a high probability that the human hand have contacted and operated the object. In short, if an object-operation-event occurs, at least a part of the image frames will detect the presence of an object operator, and the distance between the object operator and the object is within a distance threshold which is used to limit the distance between the object operator and the object to be close enough.

In addition, it should be noted that, among the image frames of the video, the image frame where the change of the object is detected and the image frame where the object operator is detected are usually relatively close in terms of capturing time of the image frames. As an example, suppose that it is determined that “an object disappeared” change has occurred based on image frames Fl to F3, for example, the object exists in the image frame F1, and the object does not exist in the image frame F3, the object operation is detected in the image frame F2, and presence of a target operator “human hand” is detected in the image frame F2, then in this case, the image frame F2 is located between the image frames F1 and F3 in time sequence. It can be seen that the appearance time of the object operator exactly matches the time when the object changes.

In the method for identifying an operation event in the examples of the present disclosure, object detection and tracking are performed on the image frames in the video to obtain the object-change-information of the object in the video, so that the corresponding object-operation-event can be automatically identified based on the object-change-information, which can achieve automatic identification of events.

FIG. 2 provides a method for identifying an operation event according to another example of the present disclosure. As shown in FIG. 2, in the method of this example, the identification of an object-operation-event will be described in detail. The method can include the following steps.

At step 200, it is determined that at least one object is detected in a first image frame according to at least one first object box detected in the first image frame.

The video can include a plurality of image frames, such as a first image frame and a second image frame, and the second image frame is located after the first image frame in time sequence.

At this step, it is assumed that at least one object box can be detected in the first image frame. In order to distinguish it from object boxes in other image frames for ease of description, the object box in the first image frame can be referred to as the first object box. For example, taking game tokens as an example, one of the object boxes can be a stack of game tokens. If there are three stacks of tokens stacked on the game table, three object boxes can be detected.

Each of the first object boxes corresponds to one object, for example, a stack of game tokens is one object. If the first image frame is the starting image frame in the video, the at least one object detected in the first image frame can be stored, and an object position, an object identification result, and an object state of each object can be obtained.

For example, the object position can be position information of the object in the first image frame.

For example, the object can include a plurality of stackable object components, and each object component has a corresponding component attribute. Then the object identification result can include at least one of the following: a number of object components or component attributes of the object components. For instance, taking one object being a stack of game tokens as an example, the object includes five game tokens, and each game token is an object component. The component attribute of the object component can be, for example, a type of the component, a denomination of the component, etc., such as the type/denomination of the game token.

For example, the object can have at least two object states, and the object in each image frame can be in one of the object states. As an example, when the object includes stackable object components, the object state can be stacking state information of the object components, for example, the object components that make up the object are in a standing and stacking state or in a state where the components are spreading.

The object position of each object can be obtained by processing the first image frame, and the object identification result and the object state can be obtained by combining information from other videos. For example, the video in the examples of the present disclosure can be captured by a top camera installed at the top of the scenario where the event occurs, and the scenario where the event occurs can also be captured by at least two cameras on its side (for example, left or right) in other videos, the image frames in the other videos can be used to identify the object identification results and object states of the objects in the scenario through a pre-trained machine learning model, and map the object identification results and object states to the object in the image frames included in the video.

At step 202, at least one second object box is detected in a second image frame, and an object position, an object identification result, and an object state corresponding to each second object box are obtained.

The second image frame is captured after the first image frame in time sequence. Similarly, at least one object box can also be detected from the second image frame, which is referred to as a second object box. Each second object box also corresponds to one object. In addition, an object position, an object identification result, and an object state of each object corresponding to the second object box can be obtained in the same manner.

At step 204, based on the object position and the object identification result, each first object corresponding to the at least one object box is compared with the second object that has been detected and stored, to establish a correspondence between the objects.

In the examples of the present disclosure, the object detected in the second image frame can be compared with the object detected in the first image frame to establish a correspondence between the objects in the two image frames. After objects are detected in the first image frame, the object positions and object identification results of these objects can be stored, and the objects in the first image frame are referred to as the first objects. After an object is detected in the second image frame, the object is referred to as a second object.

First, a position similarity matrix between a first object and a second object is established based on the object positions; and an identification result similarity matrix between the first object and the second object is established based on the object identification results. For example, taking the establishment of a position similarity matrix as an example, the Kalman Filter algorithm can be used to establish the position similarity matrix. For each first object, a predicted position corresponding to the second image frame (that is, a predicted object position corresponding to a frame time t of the second image frame) is predicted based on the object position of the first object. Then, the position similarity matrix is obtained from calculation based on the predicted positions of the first objects and the object positions (that is actual object positions) of the second objects. For another example, the identification result similarity matrix between the first objects and the second objects can be established based on a longest common subsequence in the object identification results of the first objects and the second objects.

Next, based on the position similarity matrix and the identification result similarity matrix, an object similarity matrix is obtained. For example, a new matrix can be obtained by multiplying elements of the two matrix of the position similarity matrix and the identification result similarity matrix, as the final similarity matrix, referred to as the object similarity matrix.

Finally, based on the object similarity matrix, maximum bipartite graph matching between the first objects and the second objects can be performed to determine a corresponding second object for each first object.

For example, if a first object D1 corresponds to a second object D2, it means that the first object D1 in the first image frame is just the second object D2 in the second image frame, and these two objects are actually the same object.

For another example, if a first object in the first image frame cannot find a corresponding second object in the second image frame, it means that the first object has disappeared in the second image frame.

For another example, if a second object in the second image frame cannot find the corresponding first object in the first image frame, it means that the second object is a newly appeared object in the second image frame.

At step 206, the object-change-information of the object is determined by comparing the object in the first image frame with the object in the second image frame.

The object-change-information can be how the object has changed. For example, as mentioned above, such object change can be the disappearance of the object or the appearance of a new object, or the object exists in both image frames, but the information of the object itself has changed. For example, the object state changes from standing to spreading, or the number of object components contained in the object increases or decreases, etc.

In addition, the above steps are explained using the first image frame and the second image frame as examples. In practice, an “object library” can be stored. For example, after an object is detected in the first image frame, the object is recorded in the object library, together with the object position, the object identification result and the object state of each object in the first image frame. Objects detected in subsequent image frames can be tracked with each object in the object library to find the corresponding object in the object library.

As an example, in an object library, three objects detected in the first image frame are stored in the object library, four objects are detected in the adjacent second image frame, and by comparing objects between two image frames, it can be seen that three of the objects can find the corresponding objects in the object library, and the other object is newly added, then the object position, the object identification result and the object state of the newly added object can be added to the object library, and at this time, there are four objects in the object library. Then, two objects are detected in a third image frame adjacent to the second image frame, and similarly, the objects are compared with each object in the object library. Assuming that two objects can be found in the object library, it can be learned that the other two objects in the object library is not detected in the third image frame, that is, disappear in the third image frame. In this case, the two disappeared objects can be deleted from the object library. As such, the objects detected in each image frame are compared with the objects that have been detected and stored in the object library, and the objects in the object library can be updated based on the objects in the current image frame, including adding new objects, deleting the disappeared object, or updating the object identification result and/or object state of the existing objects.

In addition, first, determining the object-change-information of the object includes determining a change in a time period, for example, the change in the time interval from time t1 to time t2, and time t1 corresponds to one image frame captured, time t2 corresponds to another image frame captured, and the number of image frames within the time interval is not limited in the examples of the present disclosure. Therefore, it is possible to determine object-change-information of an object in a time period, for example, which objects have been added, which objects have been removed, or how the object state of an object has changed.

Second, the object-change-information of the object is generally obtained after object comparison. For example, after an object in an image frame is detected, the object is compared with each object in the object library to find the corresponding object, and then it is determined which object in the object library is to be added or to be deleted. Alternatively, after finding the corresponding object, the object states of the object itself can be compared, and whether the object identification results has changed can be determined.

Third, when a change in an object is detected, whether it is an addition/deletion of the object or a change in state, sometimes misdetection can occur. In order to improve the accuracy of the detection, it is possible to provided that when a change is detected to keep existing in a preset number of consecutive image frames, it can be determined that the object-change-information of the object has occurred.

In the following, take the object object-change-information being the appearance or disappearance of the object as an example.

If an object is not detected in a part of the at least two image frames, and in a preset number of consecutive image frames after the part of image frames, the object is detected in a first target area, it can be determined that the object is a new object appearing in the first target area.

If in a part of the at least two image frames, an object is detected in a second target area, and in a preset number of consecutive image frames after the part of image frames, the object is not detected in the second target area, it can be determined that the object disappears from the second target area of the scenario where the event occurs.

In other examples, the object-change-information of the object can also include a change in the object identification result of the object, for example, an increase or decrease in the number of object components contained in the object. For another example, the object state of the object can also change, such as one object can include at least two object states, and the object in each image frame is in one of the object states. As an example, the state of the object can include spreading/standing position, and the object in a captured image frame is either in a standing state or spreading.

At step 208, if the object-change-information of the object satisfies the preset event change condition, an object operator is also detected in at least a part of the at least two image frames, and a distance between a position of the object operator and the position of the object is within a preset distance threshold, it is determined that an object-operation-event corresponding to the event change condition is occurred by the object operator operating on the object.

For example, the object-change-information of the object can occur in the time interval from time t1 to time t2, and within this time interval, the presence of an object operator (for example, a human hand) is detected within the position range of the object, that is, the distance between the object operator and the object is within a preset distance threshold, it can be determined that an object-operation-event corresponding to the event change condition is occurred by the object operator operating on the object.

As an example, if it is detected that a new object appears in at least two image frames of the video, the object can be referred to as the first object, and it is determined that the object position of the first object in the image frame is in the first target area of the image frame. In this case, the to-be-determined object-operation-event that has occurred is moving the first object into the first target area. For another example, in addition to the first object being detected as newly appeared in the first target area, a human hand is also detected to appear during this time period, and the distance between the human hand and the first object is within a preset distance threshold, it can be determined that an event of moving the first object into the first target area has occurred.

For another example, if the detected object-change-information of the object is that one object is detected to disappear from the second target area in the at least two image frames, the object can be referred to as the second object, that is, the second object was in the second target area of the image frame before disappearing. In this case, the to-be-determined object-operation-event that has occurred is moving the second object out of the second target area. For another example, in addition to the second object being moved out of the second target area, a human hand is also detected to appear during this time period, and the distance between the human hand and the second object is within a preset distance threshold, it can be determined that an event of moving the second object out of the second target area has occurred.

By detecting moving the first object into the first target area or moving the second object out of the second target area in the image, the position where the event has occurred can be automatically detected. In a scenario such as a game, the object operator (such as human hands, or the like) is allowed to operate freely in the scenario, which can achieve more flexible event identification.

For another instance, taking a third object detected in at least two image frames of the video as an example, if the object identification result of the third object is detected to have changed, it can be determined that an object-operation-event corresponding to the change in the object identification result has occurred.

As an example, detecting whether the object identification result of the third object has changed can include: detecting if there is a change in the number of the object components contained in the third object, and if the third object has object components with same component attributes before and after the change. If the number of the object components contained in the third object has changed, and the third object has object components with same component attributes before and after the change, it can be determined that the occurred object-operation-event corresponding to the change in the object identification result is increasing the object components of the object, or decreasing the object components of the object.

For example, still taking game tokens as an example, a stack of game tokens includes two game tokens with a denomination of 50. If the stack of game tokens detected in the subsequent image frame includes four game tokens with a denomination of 50, on the one hand, the four game tokens with a denomination of 50 includes the same object components as the aforementioned “two game tokens with a denomination of 50”, that is, the objects both have two game tokens with a denomination of 50; on the other hand, the number of game tokens has changed. If the number has increased, then it can be determined that an event of increasing the number of game tokens in the stack of game tokens has occurred. If the stack of game tokens detected in the subsequent image frame includes three game tokens with a denomination of 100, that is, the object “three tokens with a denomination of 100” and the aforementioned object “two tokens with a denomination of 50” are not the same game tokens of the same type or with the same denomination, so there is no object component with the same component attribute, even though the number of game tokens has increased, it cannot be determined that an event of increasing the number of game tokens has occurred. This method of combining the number and the attribute of game tokens can make event identification more accurate.

For another example, if the detected object-change-information of the object includes the object-change-information of the object state of the object, the to-be-determined object-operation-event that has occurred is an object-operation-event of controlling change in the object state. For example, when the object includes stackable object components, the object-change-information of the object state can include the stacking state information of the object components. For example, a stack of game tokens changes from the original stacked standing state to the spreading state, then it can be determined that an operation event of spreading the game tokens has occurred.

The method for identifying an operation event in the examples of the present disclosure can obtain the object-change-information of the objects in the video by detecting and tracking the objects in the image frames of the video, so that a corresponding object-operation-event can be automatically identified based on the object-change-information, which can achieve automatic identification of events. Moreover, by combining the object identification result and object position for tracking, the object can be tracked more accurately.

With the continuous development of artificial intelligence technology, many places are trying to build intelligence scenarios. For example, one of the topics is the construction of smart game venues. Then, one of the requirements for the construction of smart gaming venues is to automatically identify the operation events that have occurred in the gaming venues, for example, what operations the player has performed on the game tokens, whether the game tokens have been increased, or the game tokens have been spread, etc. The method for identifying an operation event according to the examples of the present disclosure can be used to identify operation events in a smart gaming venue.

In an exemplary tabletop game scenario, a plurality of people can sit around a game table, the game table can include a plurality of game areas, and different game areas can have different game meanings. These game areas are can be different stacking areas as described below. In addition, in a multiplayer game, users can play the game with game tokens.

For example, the user can exchange some of his own items for the game tokens, and place the game tokens in different stacking areas of the game table to play the game. For instance, a first user can exchange multiple colored marker pens he owns for game tokens used in the game, and use the game tokens between different stacking areas on the game table to play the game in accordance with the rules of the game. If a second user beats the first user in the game, the colored marker pens of the first user can belong to the second user. For example, the game is suitable for recreational activities among a plurality of family members during leisure time such as holidays.

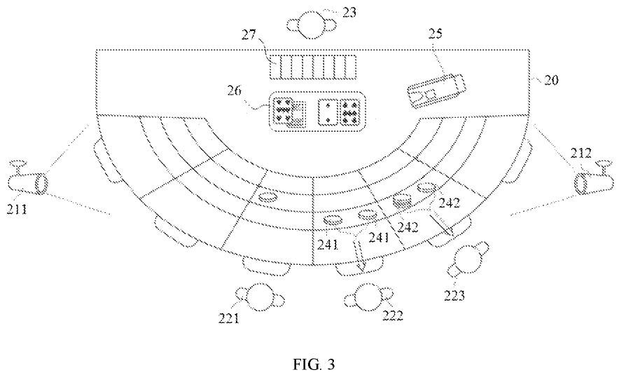

Next, take the game table shown in FIG. 3 as an example. As shown in FIG. 3, in a game scenario, a game can be played on a game table 20, and cameras 211 and 212 on both sides capture images of game tokens placed in each stacking area of the game table. User 221, user 222, and user 223 participating in the game are located on one side of the gaming table 20. The user 221, user 222, and user 223 can be referred to as a first user. Another user 23 participating in the game is located on the other side of the gaming table 20, and the user 23 can be referred to as a second user. The second user can be a user responsible for controlling the progress of the game during the game process.

At the beginning of the game, each first user can use their own exchange items (for example, colored marker pens, or other items that can be of interest to the user) to exchange for game tokens from the second user. The second user delivers game tokens placed in a game-token storage area 27 to the first user. Then, the first user can place the game tokens in a predetermined operation area on the game table, such as a predetermined operation area 241 for placement of the first user 222 and a predetermined operation area 242 for placement of the first user 223. In the game process, a card dealer 25 hands out cards to a game playing area 26 to proceed the game. After the game is completed, the second user can determine the game result based on the cards in the game playing area 26, and increase the game tokens for the first user who wins the game. The storage area 27, the predetermined operation area 241, the predetermined operation area 242, and the like can be referred to as stacking areas.

In addition, it can be seen from FIG. 3 that the game table includes a plurality of predetermined operation areas, and users (game players) deliver or recover game tokens to or from these predetermined operation areas. For example, the predetermined operation area 241 and the predetermined operation area 242, the game tokens in the predetermined operation area can be a plurality of game tokens stacked vertically on the table top of the gaming table from top to bottom.

In the examples of the present disclosure, a video taken by a bird's-eye view camera arranged above the game table can be used to determine the actions (that is, an operation event) being performed on the game table. The game table can be referred to as an event occurrence scenario, and the object in the scenario can be game tokens, for example, a stack of game tokens stacked in a predetermined operation area can be referred to as an object. The object operator in this scenario can be the hands of game participants, and the object-operation-events that can occur in this scenario can be: removing the game token/adding the game token/spreading the game token, and so on.

In addition, when using the video captured by the bird's-eye view camera to automatically identify the event in the scenario, side images of the object captured by the cameras 211 and 212 on both sides of the game table can be used to assist in identification. For example, the side images of the object captured by the side cameras can be used to identify object state or object identification result through a previously trained machine learning model, and such identified object information can be assigned to the object captured by the bird's-eye view camera. For example, information such as object positions, object numbers can be obtained based on the image frames captured by the bird's-eye view camera. Such information together with the object states/object identification results obtained by the side camera are stored in the object library. It should also be noted that, as each image frame in the video is continuously tracked and detected, the object information in the object library can be continuously updated based on the latest detected object object-change-information. For example, if an object in the object library contains five object components, and the current image frame detects that the object contains seven object components, accordingly, the number of object components contained in the object stored in the object library can be updated to seven. When the subsequent image frame detection results are compared against the object library, the number of object components can be most recently updated.

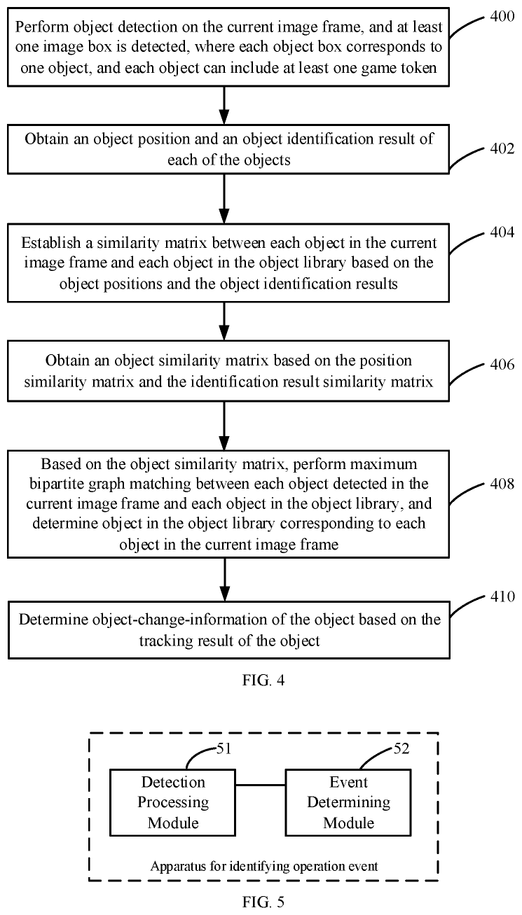

In the following, taking game tokens as an example, how to identify the operation events on the game tokens will be described with reference to FIG. 4.

For object tracking:

For example, each image frame in the video captured by the bird's-eye view camera on the game table is processed by the following steps.

At step 400, object detection is performed on the current image frame, and at least one image box is detected, where each object box corresponds to one object, and each object can include at least one game token. For example, three objects can be detected in an image frame, and these three objects can be three stacks of game tokens.

At step 402, an object position and an object identification result of each of the objects are obtained.

For example, the object position can be the position of the object in the image frame, and the object identification result can be the number of game tokens included in the object.

At step 404, a similarity matrix is established between each object in the current image frame and each object in the object library based on the object positions and the object identification results.

For example, a position similarity matrix between each object detected in the current image frame and each object in the object library can be established based on the object positions. An identification result similarity matrix between each object detected in the current image frame and each object in the object library can be established based on the object identification results. For example, if there are m objects in the object library and n objects in the current image frame, an m*n similarity matrix (position similarity matrix or identification result similarity matrix) can be established, where m and n are positive integers.

At step 406, an object similarity matrix is obtained based on the position similarity matrix and the identification result similarity matrix.

At step 408, based on the object similarity matrix, maximum bipartite graph matching is performed between each object detected in the current image frame and each object in the object library, and object in the object library corresponding to each object in the current image frame is determined.

At step 410, object-change-information of the object is determined based on the tracking result of the object.

For example, suppose that a stack of game tokens is detected in a target area in the first image frame, but cannot be detected in the second image frame afterwards, that is, the stack of game tokens in the object library does not have a corresponding object in the second image frame, it can be learned that the object object-change-information is that the stack of game tokens has disappeared from the target area.

For another example, suppose a stack of game tokens keeps existing, but it is found that the number of game tokens included in the object in the object library is five, and the number of game tokens detected in the current image frame is seven, it can be determined that the object object-change-information is that the number of the game tokens has increased.

For event identification:

After determining that the object has changed, for example, if the number of game tokens in a stack of game tokens has increased, or a stack of game tokens has disappeared, the identification of the operation events of the game tokens can be continued.

For example, if the detected object object-change-information is that within a time period T, a stack of game tokens in the first target area on the game table disappears, and it is also detected in the image frame during the same time period that a human hand appears in the area within a distance threshold range of the stack of game tokens, it can be determined that an object-operation-event of “moving the stack of game tokens out of the first target area” has occurred.

For another example, if the detected object object-change-information that within a time period T, a new stack of game tokens appears in the second target area on the game table, and it is also detected in the image frame during the same time period that a human hand appears in the area within a distance threshold range of the stack of game tokens, it can be determined that an object-operation-event of “moving a stack of game tokens into the second target area” has occurred.

For another example, if the detected object object-change-information is that when it is detected that a stack of game tokens in an area of the game table increases/decreases by one or more tokens on the original basis, the stack of game tokens before and after the change have game tokens with the same attributes, and it is also detected in the image frame during the same time period that a human hand appears in the area within a distance threshold range of the game tokens, it can be determined that an operation event of “increasing/decreasing game tokens to/from the stack of game tokens” has occurred.

For another example, if the detected object object-change-information is that when it is detected that the state of a stack of game tokens in an area of the game table changes from standing to spreading, or from spreading to standing, and it is also detected in the image frame during the same time period that a human hand appears in the area within a distance threshold range of the game tokens, it can be determined that an operation event of “spreading the stack of game tokens/folding the stack of game tokens” has occurred.

The examples of the present disclosure provide a method for identifying an operation event, which can achieve automatic identification of operation events in event occurrence scenarios, can identify corresponding operation events for different object object-change-information, and can achieve fine-grained operation event identification.

Other operation can be further performed based on the identification result of the operation event. Still taking the game scenario as an example, suppose that when the second user 23 in FIG. 3 adds game tokens to the first user who has won the game, the game tokens to be given to the first user are usually collapsed in the storage area 27 to confirm whether the number of game tokens to be awarded is correct. The demand in the smart game scenario is to automatically identify whether the game tokens to be given to the first user who has won are correct, and first it is determined which stack of game tokens on the game table are the game tokens to be given. According to the method of the examples of the present disclosure, it is possible to detect to which stack of game tokens has occurred the event of “spreading the stack of game tokens”. If it is detected that a stack of game tokens is collapsed, it can be determined that the stack of game tokens is the game tokens to be given to the first user who has won, and it can be further determined whether the amount of the game tokens is correct. For another example, when it is detected that a stack of game tokens has newly appeared with the method of the examples of the present disclosure, it can be determined that the player has invested new game tokens, and the total amount of the game tokens invested by the player can be further determined.

For another example, with the method of this example, it can be also automatically identified that a new stack of game tokens has appeared in an area of the game table, that is, when there are newly invested game tokens in this area, it is possible to confirm which player invested the stack of game tokens by identifying which player's hand is in the image frame. Identifying which player's hand can be performed in combination with images captured by the cameras on the sides of the game table. For example, the images captured by the cameras on the sides of the game table can be used to detect the association between human hands and human faces through a deep learning model, and by mapping to the image frames captured by the bird's-eye view camera through a multi-camera merging algorithm to learn which user is investing game tokens.

For another example, with the method of the examples of the present disclosure, it is also possible to automatically detect the event that the player operates a marker on the game table, and confirm switching of the game stage.

FIG. 5 illustrates a schematic block diagram of an apparatus for identifying an operation event according to at least one example of the present disclosure. The apparatus can be applied to implement the method for identifying an operation event in any example of the present disclosure. As shown in FIG. 5, the apparatus can include: a detection processing module 51 and an event determining module 52.

The detection processing module 51 is configured to perform object detection and tracking on at least two image frames of a video to obtain object-change-information of an object involved in the at least two image frames, wherein the object is an operable object.

The event determining module 52 is configured to determine an object-operation-event that has occurred based on the object-change-information of the object.

In an example, when the event determining module 52 is configured to determine an occurred object-operation-event based on the object-change-information, in response to that the object-change-information satisfies a preset event change condition, and an object operator is detected in at least a part of the at least two image frames, and a distance between a position of the object operator and a position of the object is within a preset distance threshold, determines that an object-operation-event corresponding to the event change condition is occurred by the object operator operating on the object.

In an example, when the detection processing module 51 is configured to perform object detection and tracking on at least two image frames of a video to obtain object-change-information of an object involved in the at least two image frames, detects a first object newly appeared in the at least two image frames, and determines an object position where the first object appeared in the at least two image frames as a first target area.

The event determining module 52 is specifically configured to determine that the occurred object-operation-event is moving the first object into the first target area.

In an example, when the detection processing module 51 is configured to perform object detection and tracking on at least two image frames of a video to obtain object-change-information of an object involved in the at least two image frames, detects a second object that has disappeared from the at least two image frames, and determines an object position where the second object appeared in the at least two image frames before the second object disappears, as a second target area.

The event determining module 52 is specifically configured to determine that the occurred object-operation-event is removing the second object out of the second target area.

In an example, when the detection processing module 51 is configured to perform object detection and tracking on at least two image frames of a video to obtain object-change-information of an object involved in the at least two image frames, detects a change in an object identification result with respect to a third object involved in the at least two image frames.

The event determining module 52 is specifically configured to determine that an object-operation-event corresponding to the change in the object identification result has occurred.

In an example, when the detection processing module 51 is configured to detect a change in an object identification result with respect to a third object involved in the at least two image frames, detects a change in a number of object components contained in the third object, and detects whether the third object has an object component of which the component attribute is same before and after the change, where the third object includes a plurality of stackable object components, and each of the object components has corresponding component attributes; the object identification result includes at least one of: a number of object components, and the component attributes of the object components.

When the event determining module 52 is configured to determine that an object-operation-event corresponding to the change in the object identification result has occurred, in response to detecting that a change has occurred in the number of object components contained in the third object and the third object has an object component of which the component attribute is same before and after the change, determines that the occurred object-operation-event is increasing or decreasing the number of object components contained in the third object.

In an example, when the event determining module 52 is configured to determine an occurred object-operation-event based on the object-change-information, determines, according to object-change-information on object state, that the occurred object-operation-event is an operation event of controlling change of object states, where the object has at least two object states, and an object involved in each of the at least two image frames is in one of the object states, and object-change-information includes object-change-information on object state of an object.

In an example, the detection processing module 51 is specifically configured to: detect a respective object position of an object in each of the at least two image frames of the video; identify the object detected in each of the at least two image frames to obtain respective object identification results; based on the respective object positions and the respective object identification results of objects detected in different image frames, compare the objects detected in the different image frames to obtain object-change-information of the object involved in the at least two image frames.

In some examples, the above-mentioned apparatus can be configured to execute any corresponding method described above. For the sake of brevity, details will not be elaborated herein.

The examples of the present disclosure also provide an electronic device, the device includes a memory and a processor, the memory is configured to store computer-readable instructions, and the processor is configured to invoke the computer instructions to implement the method of any of the examples of the present specification.

The examples of the present disclosure also provide a computer-readable storage medium on which a computer program is stored, and when the program is executed by a processor, the processor implements the method of any of the examples of the present specification.

The examples of the present disclosure also provide a computer-readable storage medium on which a computer program is stored, and when the program is executed by a processor, the processor implements the method of any of the examples of the present specification.

The examples of the present disclosure also provide a computer program, including computer-readable codes which, when executed in an electronic device, cause a processor in the electronic device to perform the method of any of the examples of the present specification.

Those skilled in the art should understand that one or more examples of the present disclosure can be provided as a method, a system, or a computer program product. Therefore, one or more examples of the present disclosure can adopt the form of a complete hardware example, a complete software example, or an example combining software and hardware. Moreover, one or more examples of the present disclosure can be embodied in a form of a computer program product implemented on one or more computer-usable storage media (including but not limited to disk storage, CD-ROM, optical storage, etc.) containing computer-usable program codes.

The examples of the present disclosure also provide a computer-readable storage medium, and the storage medium can store a computer program. When the program is executed by a processor, the processor implements steps of the method for identifying an operation event.

As used herein, “and/or” in the examples of the present disclosure means having at least one of the two, for example, “multi and/or B” includes three schemes: multi, B, and “multi and B”.

The various examples in the present disclosure are described in a progressive manner, and the same or similar parts between the various examples can be referred to each other, and each example focuses on the differences from other examples. In particular, for the data processing device examples, since they are basically similar to the method examples, the description is relatively simple, and for related parts, reference can be made to the part of description of the method examples.

The specific examples of the present disclosure have been described above. Other examples are within the scope of the appended claims. In some cases, the actions or steps described in the claims can be performed in a different order than in the examples and still achieve desired results. In addition, the processes depicted in the drawings do not necessarily require the specific order or sequential order shown to achieve the desired result. In some examples, multitasking and parallel processing are also possible or can be advantageous.

The examples of the subject and functional operations described in the present disclosure can be implemented in the following: digital electronic circuits, tangible computer software or firmware, computer hardware including the structures disclosed in the present disclosure and structural equivalents thereof, or a combination of one or more. The examples of the subject matter described in the present disclosure can be implemented as one or more computer programs, that is, one or one modules of computer program instructions encoded on a tangible non-transitory program carrier to be executed by a data processing device or to control the operation of the data processing device. Alternatively or in addition, the program instructions can be encoded on artificially generated propagated signals, such as machine-generated electrical, optical or electromagnetic signals, which are generated to encode the information and transmit the same to a suitable receiver device for execution by the data processing device. The computer storage medium can be a machine-readable storage device, a machine-readable storage substrate, a random or serial access memory device, or a combination of one or more thereof.

The processing and logic flow described in the present disclosure can be executed by one or more programmable computers executing one or more computer programs to perform corresponding functions by operating according to input data and generating output. The processing and logic flow can also be executed by a dedicated logic circuit, such as FPG Multi (Field Programmable Gate Array) or Multi SIC (Application Specific Integrated Circuit), and the device can also be implemented as a dedicated logic circuit.

Computers suitable for executing computer programs include, for example, general-purpose and/or special-purpose microprocessors, or any other type of central processing unit. Generally, the central processing unit will receive instructions and data from a read-only memory and/or random access memory. The basic components of a computer include a central processing unit for implementing or executing instructions and one or more memory devices for storing instructions and data. Generally, the computer will also include one or more mass storage devices for storing data, such as magnetic disks, magneto-optical disks, or optical disks, or the computer will be operatively coupled to this mass storage device to receive or send data from or to it, or both. However, the computer does not have to have such equipment. In addition, the computer can be embedded in another device, such as a mobile phone, personal digital assistant (PD multi), mobile audio or video player, game console, global positioning system (GPS) receiver, or, for example, a universal serial bus (USB) flash drives are portable storage devices, to name a few.

Computer-readable media suitable for storing computer program instructions and data include all forms of non-volatile memory, media, and memory devices, including, for example, semiconductor memory devices (such as EPROMs, EEPROMs, and flash memory devices), magnetic disks (such as internal hard disks or Removable disks), magneto-optical disks, CD ROM and DVD-ROM disks. The processor and the memory can be supplemented by or incorporated into a dedicated logic circuit.

Although the present disclosure contains many specific implementation details, these should not be construed as limiting the scope of any disclosure or the scope of protection, but are mainly configured to describe the features of specific examples of the specific disclosure. Certain features described in multiple examples within the present disclosure can also be implemented in combination in a single example. On the other hand, various features described in a single example can also be implemented in multiple examples separately or in any suitable sub-combination. In addition, although features can function in certain combinations as described above and even initially claimed as such, one or more features from the claimed combination can in some cases be removed from the combination, and the claimed combination of protection can be directed to a sub-combination or a variant of the sub-combination.

Similarly, although operations are depicted in a specific order in the drawings, this should not be understood as requiring these operations to be performed in the specific order shown or sequentially, or requiring all illustrated operations to be performed to achieve the desired result. In some cases, multitasking and parallel processing can be advantageous. In addition, the separation of various system modules and components in the above examples should not be understood as requiring such separation in all examples, and it should be understood that the described program components and systems can usually be integrated together in a single software product. In, or packaged into multiple software products.

Thus, specific examples of the subject matter have been described. Other examples are within the scope of the appended claims. In some cases, the actions recited in the claims can be performed in a different order and still achieve desired results. In addition, the processes depicted in the drawings are not necessarily in the specific order or sequential order shown in order to achieve the desired result. In some implementations, multitasking and parallel processing can be advantageous.

The foregoing descriptions are only preferred examples of one or more examples of the present disclosure, and are not configured to limit one or more examples of the present disclosure. Within the spirit and principle of one or more examples of the present disclosure, any modification, equivalent replacement, improvement, etc. made should be included in the protection scope of one or more examples of the present disclosure.

1. A method for identifying an operation event, the method comprising:
performing object detection and tracking on at least two image frames of a video to obtain object-change-information of an object involved in the at least two image frames, wherein the object is an operable object; and
determining an occurred object-operation-event based on the object-change-information.

2. The method of claim 1, wherein determining an occurred object-operation-event based on the object-change-information comprises:
in response to determining that the object-change-information satisfies a preset event change condition, an object operator is detected in at least a part of the at least two image frames, and a distance between a position of the object operator and a position of the object is within a preset distance threshold, determining that an object-operation-event corresponding to the event change condition has occurred by the object operator operating on the object.

3. The method of claim 2, wherein the object operator comprises a hand or an object holding tool.

4. The method of claim 1, wherein performing object detection and tracking on at least two image frames of a video to obtain object-change-information of an object involved in the at least two image frames comprises:
detecting a first object newly appeared in the at least two image frames, and
determining an object position, where the first object appeared in the at least two image frames, as a first target area, and
wherein determining an occurred object-operation-event based on the object-change-information comprises:
determining that the occurred object-operation-event is moving the first object into the first target area.

5. The method of claim 1, wherein performing object detection and tracking on at least two image frames of a video to obtain object-change-information of an object involved in the at least two image frames comprises:
detecting a second object that has disappeared from the at least two image frames, and
determining an object position, where the second object appeared in the at least two image frames before the second object disappears, as a second target area, and
wherein determining an occurred object-operation-event based on the object-change-information comprises:
determining that the occurred object-operation-event is removing the second object out of the second target area.

6. The method of claim 1, wherein performing object detection and tracking on at least two image frames of a video to obtain object-change-information of an object involved in the at least two image frames comprises:
detecting a change in an object identification result with respect to a third object involved in the at least two image frames, and
wherein determining an occurred object-operation-event based on the object-change-information comprises:
determining that an object-operation-event corresponding to the change in the object identification result has occurred.

7. The method of claim 6, wherein the third object comprises a plurality of stackable object components, and each of the object components has a respective component attribute,
wherein the object identification result comprises at least one of: a number of the object components, or a respective component attribute of at least one of the object components,
wherein detecting a change in an object identification result with respect to a third object involved in the at least two image frames comprises:
detecting a change in the number of object components contained in the third object, and
detecting whether the third object has an object component of which the respective component attribute is same before and after the change, and
wherein determining that an object-operation-event corresponding to the change in the object identification result has occurred comprises:
in response to detecting that a change has occurred in the number of object components contained in the third object and the third object has an object component of which the respective component attribute is same before and after the change, determining that the occurred object-operation-event is increasing or decreasing the number of object components contained in the third object.

8. The method of claim 1, wherein the object has at least two object states, and an object involved in each of the at least two image frames is in one of the object states,
wherein the object-change-information comprises object-change-information on object state of an object, and
wherein determining an occurred object-operation-event based on the object-change-information comprises:
determining, according to the object-change-information on object state, that the occurred object-operation-event is an operation event of controlling change of object states.

9. The method of claim 8, wherein the object comprises stackable object components, and
wherein the object-change-information comprises stacking state information of the object components.

10. The method of claim 1, wherein performing object detection and tracking on at least two image frames of a video to obtain object-change-information of an object involved in the at least two image frames comprises:
detecting a respective object position of an object in each of the at least two image frames of the video;
identifying the object detected in each of the at least two image frames to obtain respective object identification results; and
based on the respective object positions and the respective object identification results of objects detected in different image frames, comparing the objects detected in the different image frames to obtain object-change-information of the object involved in the at least two image frames.

11. A device comprising::
at least one processor; and
one or more memories coupled to the at least one processor and storing programming instructions for execution by the at least one processor to perform operations comprising:
performing object detection and tracking on at least two image frames of a video to obtain object-change-information of an object involved in the at least two image frames, wherein the object is an operable object; and
determining an occurred object-operation-event based on the object-change-information.

12. The device of claim 11, wherein determining an occurred object-operation-event based on the object-change-information comprises:
in response to determining that the object-change-information satisfies a preset event change condition, an object operator is detected in at least a part of the at least two image frames, and a distance between a position of the object operator and a position of the object is within a preset distance threshold, determining that an object-operation-event corresponding to the event change condition has occurred by the object operator operating on the object.

13. The device of claim 12, wherein the object operator comprises a hand or an object holding tool.

14. The device of claim 11, wherein performing object detection and tracking on at least two image frames of a video to obtain object-change-information of an object involved in the at least two image frames comprises:
detecting a first object newly appeared in the at least two image frames, and
determining an object position where the first object appeared in the at least two image frames as a first target area, and
wherein determining an occurred object-operation-event based on the object-change-information comprises:
determining that the occurred object-operation-event is moving the first object into the first target area.

15. The device of claim 11, wherein performing object detection and tracking on at least two image frames of a video to obtain object-change-information of an object involved in the at least two image frames comprises:
detecting a second object that has disappeared from the at least two image frames, and
determining an object position where the second object appeared in the at least two image frames before the second object disappears, as a second target area, and
wherein determining an occurred object-operation-event based on the object-change-information comprises:
determining that the occurred object-operation-event is removing the second object out of the second target area.

16. The device of claim 11, wherein performing object detection and tracking on at least two image frames of a video to obtain object-change-information of an object involved in the at least two image frames comprises:
detecting a change in an object identification result with respect to a third object involved in the at least two image frames, and
wherein determining an occurred object-operation-event based on the object-change-information comprises:
determining that an object-operation-event corresponding to the change in the object identification result has occurred.

17. The device of claim 16, wherein the third object comprises a plurality of stackable object components, and each of the object components has a respective component attribute,
wherein the object identification result comprises at least one of: a number of the object components, or a respective component attribute of at least one of the object components,
wherein detecting a change in an object identification result with respect to a third object involved in the at least two image frames comprises:
detecting a change in the number of the object components contained in the third object, and
detecting whether the third object has an object component of which the respective component attribute is same before and after the change, and
wherein determining that an object-operation-event corresponding to the change in the object identification result has occurred comprises:
in response to detecting that a change has occurred in the number of object components contained in the third object and the third object has an object component of which the respective component attribute is same before and after the change, determining that the occurred object-operation-event is increasing or decreasing the number of object components contained in the third object.

18. The device of claim 11, wherein the object has at least two object states, and an object involved in each of the at least two image frames is in one of the object states,
wherein the object-change-information comprises object-change-information on object state of an object, and
wherein determining an occurred object-operation-event based on the object-change-information comprises:
determining, according to the object-change-information on object state, that the occurred object-operation-event is an operation event of controlling change of object states.

19. The device of claim 18, wherein the object comprises stackable object components, and
wherein the object-change-information comprises stacking state information of the object components.

20. A non-transitory computer-readable storage medium coupled to at least one processor and storing programming instructions for execution by the at least one processor to:
perform object detection and tracking on at least two image frames of a video to obtain object-change-information of an object involved in the at least two image frames, wherein the object is an operable object; and
determine an occurred object-operation-event based on the object-change-information.
